(19) United States
(12) Patent Application Publication
(10) Pub. No.: US 2008/0055773 A1
(43) Pub. Date: Mar. 6, 2008

(54) Multi-Platter Flexible Media Disk Drive Arrangement

(75) Inventor: Anil Nigam, Saratoga, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Antek Peripherals, Inc., Saratoga, CA (US)

(21) Appl. No.: 11/843,482

(22) Filed: Aug. 22, 2007

Related U.S. Application Data
(60) Provisional application No. 60/823,883, filed on Aug. 29, 2006.

(51) Int. Cl. G11B 5/016

(52) U.S. Cl. 360/99.01

(57) ABSTRACT

According to the invention, a data storage system is disclosed. The system may include a housing, a spindle motor, a plurality of flexible disks, a first head, a second head, a first mechanism, and a second mechanism. The spindle motor may be coupled with the housing and operably coupled with the plurality of flexible disks which may be spaced apart from each other. Both heads may be configured to engage different faces of a flexible disk, and may be aligned substantially parallel with each other. The first mechanism may be configured to move both heads along different faces of one flexible disk. The second mechanism may be configured to move both heads in a plane substantially perpendicular to that flexible disk and position them to engage another flexible disk, where at least one head includes a transducer configured to read and write information on the flexible disks.

### CROSS-REFERENCE TO RELATED APPLICATIONS

This application claims priority to provisional U.S. Patent Application No. 60/823,883 filed Aug. 29, 2006, entitled “MULTI-PLATTER FLEXIBLE MEDIA DISK DRIVE ARRANGEMENT,” the entire disclosure of which is hereby incorporated by reference, for all purposes, as if fully set forth herein.

### BACKGROUND OF THE INVENTION

The Hard Disk Drive (HDD) is the predominant data storage mechanism that is used in Notebook PCs, Desktops and Servers today. The recording medium consists of a rigid disk (HD) made from an Aluminum or a Glass substrate that is about 95 mm to 65 mm in diameter with a thickness in the range of about 1.27 mm to 0.635 mm. In compact form factor disk drives the disk diameters can be as small as 21.6 mm with a thickness that is about 0.38 mm. The architecture of the HDD consists of at least one HD and a recording head configured to operate on at least one face of this disk. The recording head flies over the disk surface supported by a very thin air film which develops when the disk spins at a high rotational speed. The recording head is mounted to an arm and driven by an electro-magnetic actuator arrangement to move over the disk platter at a fast speed.

High data storage capacity on each HD is achieved by recording a large number of data tracks per disk surface along with a large number of data bits per track. The technology of the magnetic film deposited on the disk, the geometry of the recording transducer attached to each head and the associated manufacturing processes are improving at a very rapid rate, allowing many more bits of information to be recorded per square inch on the disk surface. To further increase the storage capacity of each HDD, additional disk platters and recording heads are utilized.

Merely by way of example, a HDD in a RAID installation can have four disk platters and eight recording heads. The method to record and retrieve data from this device consists of reading or writing on one head and one track at a time. A head switch to access another disk platter or a track change on the same platter consumes time, which could be several milli-seconds. Furthermore, as one head is reading or writing information on a data track the other seven heads are creating air drag and causing the unit to consume power. This power consumption is becoming significant as Storage Networks, Data Centers and Server Farms, which utilize a large number of HDD units, are being created to support the information storage requirements of both the Consumer and the Enterprise customer.

Studies on data storage utilization have shown that in a typical RAID installation approximately 30% of the information is accessed repeatedly, while 70% is accessed infrequently, but is kept on the HDD along with the frequently accessed data. This is done to provide rapid access to this information when requested. An alternative is to “off-load” data from the HDD to Tape. However, Tape is a sequential storage device and retrieval of a file entails identifying and searching for a specific tape cartridge, mounting it in a Tape Drive mechanism, and then sequentially searching for the requested information. All this consumes time, in the order of several minutes to even hours, making it inconvenient for the requester and consequently more data is being kept “on-line” requiring more HDD units that consume more power.

It is an object of this disclosure to describe a disk drive mechanism that increases the storage capacity of each HDD without changing its physical form factor or requiring modifications to the Server software, while lowering the power consumed by each unit. Additionally, the device architecture disclosed can be employed in a smaller, thinner, and more convenient disk drive form factor to achieve a low-cost random-access archival storage device as an alternative to the Tape cartridge and Tape drive. Finally, it is also an object of this disclosure to describe a disk drive with reduced inertia of the rotating disk pack to achieve even faster disk speeds for increased data throughput.

### BRIEF SUMMARY OF THE INVENTION

In one embodiment, a data storage system is provided. The data storage system may include a housing, a spindle motor, a plurality of flexible disks, a first head, a second head, a first mechanism, and a second mechanism. The spindle motor may be coupled with the housing. The plurality of flexible disks may be spaced apart from each other, and may be operably coupled with the spindle motor to rotate therewith. The plurality of flexible disks may include a first flexible disk and a second flexible disk. The first head may be configured to engage the first face of the first flexible disk. The second head may be configured to engage the second face of the first flexible disk, and may be aligned substantially opposed to the first head. The first mechanism may be configured to move both the first head and the second head along both the first face and the second face of the first flexible disk. The second mechanism may be configured to move both the first head and the second head in a plane substantially perpendicular to the first flexible disk and position them to engage the second flexible disk. One or both of the first head and the second head may include a transducer configured to read and write information on at least one face of at least one of the plurality of flexible disks.

In another embodiment, another data storage system is provided. The data storage system may include a housing, a spindle motor, a plurality of flexible disks, a magnet structure, an arm, and a platform. The spindle motor may be coupled with the housing. The plurality of flexible disks may be spaced apart from each other and may be operably coupled with the spindle motor to rotate therewith. The magnet structure may be coupled with the housing, and the magnet structure may generate a magnetic field in an air gap. The arm may be configured to rotate around a first axis, and the arm may include a coil at a first end of the arm, and at least one head at a second end of the arm. The coil may be at least partially located in the air gap and may be configured to move in a plane substantially perpendicular to the first axis. The platform may be operably coupled with an actuator coupled with the housing, and may be configured to move the platform along the first axis, where the platform may be configured to move the arm along the first axis when the arm is at a home position.

In another embodiment, another data storage system is provided. The data storage system may include a first means, a second means, a third means, a fourth means, a fifth means, a sixth means, and a seventh means. The first means may be for storing data, and may include any of a flexible disk or any other components described herein. The second means may also be for storing data, and may also include any of a flexible disk or any other components described here. The third means may be for rotating the first means and the second means, and may include a spindle motor or any of the other components described herein. The fourth means may be for providing air flow between the first means and the second means, and may include a spindle motor, annular cavities in a spindle motor shaft, or any of the other components described herein. The fifth means may be for reading or writing data, and may include a head or any of the other components described herein. The sixth means may be for moving the fifth means between different portions of either one of the first means or the second means, and may include a magnet and/or electric coils, motors, or any of the other components described herein. The seventh means may be for moving the fifth means from the first means and the second means, and may include a magnet and/or electric coils, motors, or any of the other components described herein.

### BRIEF DESCRIPTION OF THE DRAWINGS

The present invention is described in conjunction with the appended figures:

FIG. 1 depicts a prior art disk drive arrangement utilizing thick hard disk platters;

FIG. 2 illustrates the disk drive arrangement of a specific embodiment utilizing flexible metal foil disks;

FIG. 3 illustrates in plan view a rotary actuator with a flat actuator coil;

FIG. 4 shows a side view of the rotary actuator of FIG. 3;

FIG. 5 illustrates in plan view a rotary actuator with a rectangular coil;

FIG. 6 shows a side view of the rotary actuator of FIG. 5;

FIG. 7 illustrates in plan view the arrangement of a rotary actuator and the recording disk, where the actuator is shown in three positions: retracted, close to the outer radius on the disk, and close to the inner recording radius on the disk;

FIG. 8 illustrates a side view of the rotary actuator arm, head cam and platter access mechanism;

FIG. 9 shows a detent-lock mechanism of the rotary actuator in the locked position;

FIG. 10 illustrates the detent-lock mechanism of FIG. 9 in the unlocked position;

FIG. 11 illustrates a detent-lock mechanism utilizing a piezoelectric material, where the piezoelectric member is shown in an unlocked state using dashed lines.;

FIG. 12 shows a rotary actuator arm with a cam follower type actuation mechanism to access different platters in a disk pack;

FIG. 13 illustrates the magnetic field intensity in the voice coil motor shown in FIGS. 3 and 4;

FIG. 14 shows the magnetic field intensity in the voice coil motor shown in FIGS. 5 and 6;

FIG. 15 illustrates a flexible disk with a rigid member located at its outer periphery;

FIG. 16 shows a flexible disk with a symmetrically configured rigid member located at its outer periphery;

FIG. 17 illustrates the boundary layer formed between a rigid member and a spinning flexible disk;

FIG. 18 shows a multi-platter disk pack arrangement with spacers that allow air flow between the platters for stability and a compressor configured at the top of the pack to provide a pressurized air volume at the center of the spindle;

FIG. 19 shows a compressor plate used to created a pressured air volume;

FIG. 20 illustrates the mechanical and electronic sub-assemblies in a disk drive;

FIG. 21 shows an arrangement consisting of an array of mechanical head/disk assemblies, power supply management logic and disk drive control electronics;

FIG. 22 illustrates an arrangement where disk drive control electronics are configured to service a set of head/disk assemblies;

FIG. 23 shows in plan view a head-arm and actuator arrangement with a flat coil;

FIG. 24 illustrates in side view the configuration of the flat coil head actuator system of FIG. 23;

FIG. 25 shows in side view the actuator system of FIG. 23 with the coil located outside the bearing supports; and

FIG. 26 illustrates a flexible disk with holes fabricated at the disk clamping diameter.

In the appended figures, similar components and/or features may have the same numerical reference label. Further, various components of the same type, or particular components in different positions, may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

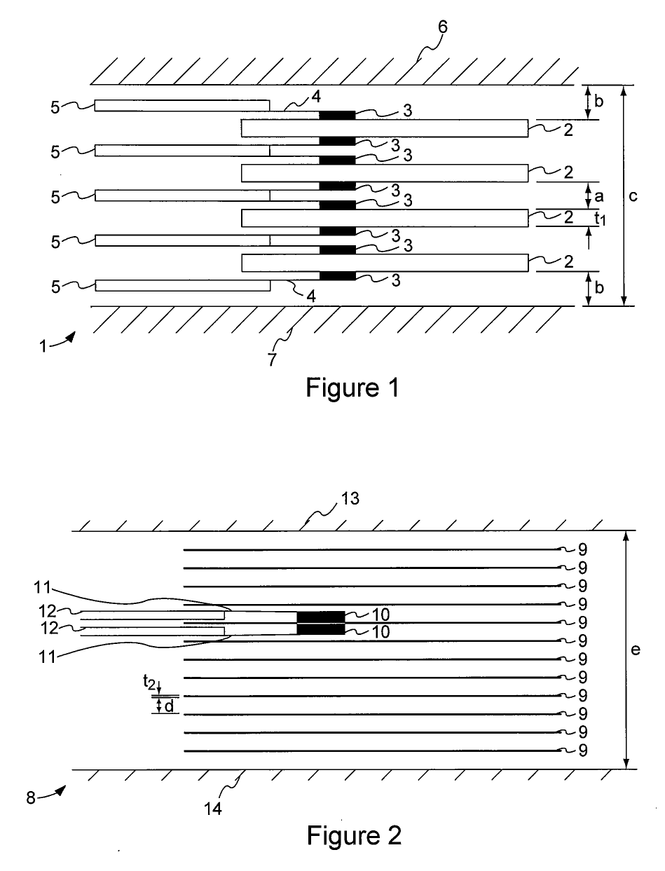

FIG. 1 illustrates a typical prior art high capacity Disk Drive. Disks 2 are spaced apart by a distance “a” and separated from the housing 6 and 7 by a distance “b”. These disks are rotated by a spindle motor (not shown) about an axis that passes through their center. Gimbal 4 attaches the recording head slider 3 to arm 5 and provides a force pushing slider 3 towards the disk surface. As the disk spins at high speed, such as 3000 rotations per minute (“rpm”) and larger, the air adjacent to the disk moves at about the speed of the disk while the air adjacent to the slider face is almost stationary. This velocity gradient creates a pressure which balances the applied load of gimbal 4 to keep slider 3 in a non-contact condition with the disk surface. A recording transducer attached to the trailing edge of 3 is used to read and write data. The arms 5, gimbals 4, sliders 3 and disks 2 all create air drag.

When the HDD is not transferring data, or for a pre-selected time period after the last transmission, the arms and the recording heads may be retracted away from the disk surfaces to reduce air drag. The inertia of the disks, the size of available spindle motors, and the power supply result in an HDD taking about five to twenty-five seconds, depending on disk diameter and disk thickness, to go from a stopped condition to operating speeds. Due to this large delay, the disks are maintained at operating speed and the recording heads in certain designs could be configured to retract and be launched on to the disk surfaces as a part of a power management algorithm. This retract and launch operation requires very precise control of the distance moved between the retracted position and the launched position to avoid instability which could result in head and disk contact causing damage or even a head crash. In one possible four (4) platter HDD arrangement the HD is 0.8 mm thick (t₁) the disk spacing “a” is 1.27 mm, and the value of “b” is 0.635 mm. The total pack height “c” is then 8.28 mm.

FIG. 2 illustrates an exemplary embodiment of this disclosure. Disks 9 may be substrates constructed at least in part with, merely by way of example, 316 Stainless Steel, non magnetic Nickel, or Permalloy, possibly with a magnetic coating which may be about 25 microns thick (t₂). Recording heads 10 may be positioned on either side of disk 9. The diameter, thickness, t₂, and the spacing of the flexible disks can be selected to minimize any disk droop at the outer diameter which could result in contact with adjacent disk surfaces. Permalloy or another soft magnetic material substrate can also be selected as the substrate material, as this could eliminate the thick magnetic return path film that may be required for Perpendicular Magnetic Recording films. In other embodiments, a flexible disk made from a plastic or other flexible material with a magnetic recording film coating on both sides of each disk could be utilized.

In one embodiment, arms 12 may be about 60% as thick as the arms of the HDD of FIG. 1. Thinner arms can be used because only one gimbal 11 is attached to each arm 12 compared to two in the HDD. The recording heads may be arranged to oppose each other with disk 9 sandwiched between these heads. Gimbal 11 may provide a load which pushes sliders 10 towards disk 9 and each other. An air bearing may be established between slider 10 and the adjacent surface of disk 9. Since disk 9 may be flexible, sliders 10 and disk 9 attain an equilibrium non-contact condition. A recording transducer located at the trailing edge of each one of the sliders 10 reads and writes data. The access motion of arm 12 in the plane of disk 9 is similar to the HDD, as well as the method of retracting the arm from the disk pack. Given thinner arms 12, and a 95 mm diameter disk 9 with a thickness of about 25 microns and spacing “d” of 0.61 mm, twelve disks can be housed in approximately the same space as the four HD's of FIG. 1. If the disk droop at the outer diameter is larger than 0.3 mm the number of disks in the stack can be reduced and spacing “d” increased.

Assuming similar recording densities for disk 2 and disk 9, and twelve flexible disks, this device may have 3 times the data storage capacity in the same physical form factor. Additionally, there may be only two recording head assemblies versus eight in the HDD. The power consumption required to overcome actuator drag may be significantly lower, however, there may also be additional drag due to “skin-friction” on twelve disks versus four in the HDD. It has been shown experimentally that disk “skin-friction” is a smaller drag component than stagnation air drag of the actuator components. Consequently, the power consumption during operation at similar disk speeds for the configuration shown in FIG. 2 may be lower, or about the same, as that of FIG. 1. However, the spinning mass of the configuration in FIG. 2, the Flexible Metal Drive (FMD), is about 3.7 times smaller. This arrangement could go from a stopped condition to operational speeds using the same spindle motor and power supply as the HDD in a much shorter time period. Thus, it may now be possible to retract the recording heads and stop the disks from spinning, rather than have a long idle period where the HD's continue to rotate and consume power.

In one embodiment, consider a data transfer rate of 100 Mbytes per second for both the HDD and the FMD, and a request for 100 Mbytes of data. The HDD, as a 3½″ form factor product with 0.8 mm thick disks, may spin up in about fifteen seconds, transfer the requested information in about one second, idle for at least a duration equal to the spin-up time period prior to retracting the heads, and then spend another similar time period awaiting a possible new request prior to stopping the spindle motor. The product would have consumed thirty-one seconds at maximum power and fifteen seconds at a lower power setting, for example a 30% level. In an FMD of a similar form factor, the drive may spin-up in approximately four seconds, transfer the data in one second, spend four seconds of idle time, spend another 4 seconds with the heads retracted, and then the disks may be stopped assuming the same algorithm as the HDD example. In this example, the FMD would have consumed nine seconds at maximum power and four seconds at 30% power, or only about 28% of the total power of the HDD. Considering other situations when a request for data is received during the idle periods, the power consumption of the FMD may increase as it will be operational for a longer time period, but on an average the power consumed may be much lower than the HDD in a typical application.

The cost of the flexible metal disk (FD) can be about 50% of the HD as discussed in U.S. Pat. Nos. 5,968,627 and 6,113,753. The cost of the recording components used in the FMD, as configured in FIG. 2, may be about 65% the cost of the HDD shown in FIG. 1. This analysis assumes an HD cost of about $5.00 and a recording head cost of about $5.50. At equivalent manufacturing volumes, the cost of the recording head used in the FMD may be the same as the HDD. Based upon these costs, a 3× storage capacity increase, and power consumption of about 0.3×, the FMD can achieve a larger than 4× reduction in $/GB and about 9× reduction in Watts/GB. These attributes of the FMD may make it very attractive for use in Server farms and Data Centers as a fewer number of Disk Drive units may be required to achieve a target storage capacity while drawing less power.

The HDD of FIG. 1 could be a 2½″ HDD with two 65 mm diameter Glass HD's that are 0.63 mm thick and spaced 1.27 mm apart with a separation of 0.63 mm from the housing. In one embodiment, a similar diameter FMD with Titanium disks that are 22 microns thick, paced 0.60 mm apart, could have five platters and two recording heads in the same physical form factor. The data storage capacity may be 2.5× larger, with a $/GB reduction of about 3.5×. A typical 2½″ HDD with two HD platters and four recording heads has a convenient form factor that is about 100 mm long, 70 mm wide and 9.5 mm thick. The FMD with flexible metal disks may be much more durable than the Glass platter HDD and could be utilized instead of Tape as a random access, archival storage device with very fast data transfer speeds.

“On-line” data storage in a RAID may require very fast data throughput. This is presently accomplished by increasing the rotational speed of the HDD disk platters to 15,000 rpm to increase data transfer rates and reduce rotational latencies. The rotary inertia of a ninety-five mm Aluminum HD that is 1.27 mm thick is about nine times larger than a similar FD fabricated using a 316 Stainless Steel sheet that is fifty microns thick. It is possible, using the same electro-mechanical elements and power supply, and other features described in this disclosure to increase the rotational speed of an FD beyond what could be attained with the HD to achieve even faster data throughput and smaller rotational latencies. This product could be configured similar to the HDD of FIG. 1 with a recording head per each disk surface, and in another embodiment since the FD is thinner than the HD, at least one additional disk and two recording heads can be mounted increasing the data storage capacity of the product by 1.25× without changing the cost of the unit. This analysis may assume that the FD can be produced for about 50% of the cost of the HD, and the HDD has four 1.27 mm thick platters spaced 2.5 mm apart. The flexible metal disk drive may have five disk platters which may be fifty micron thick, spaced apart by about 3.0 mm to attain the same product thickness.

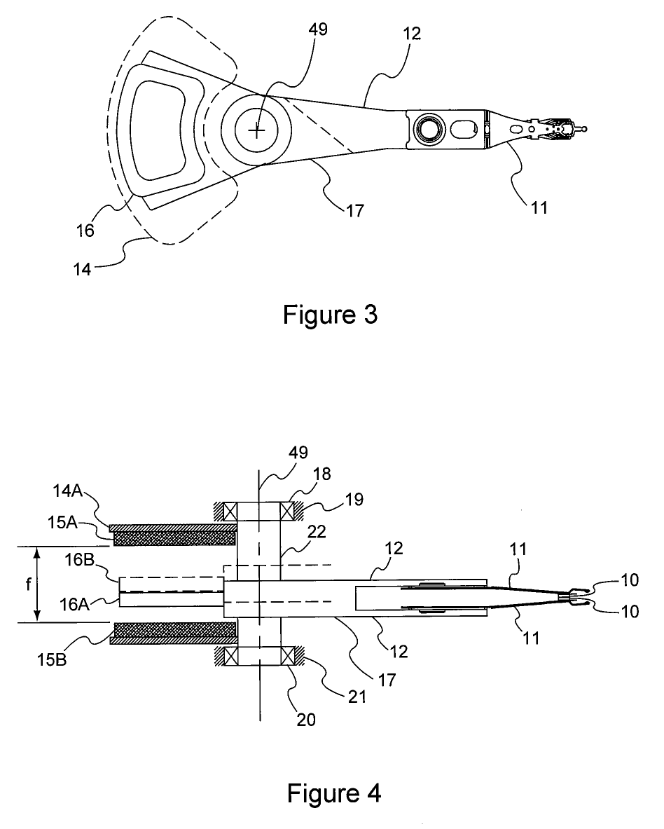

In the FMD shown in FIG. 2, the two recording heads must be moved in the plane of the disk and on an axis that is perpendicular to the face of the disk. FIGS. 3 and 4 illustrate one embodiment of the invention which accomplishes this. Head gimbals 11 may be attached to actuator arm 12 along with the Voice Coil Motor coil 16. Arms 12 could be a feature fabricated in actuator arm 17. The actuator assembly consisting of recording heads 10, gimbals 11 and coil 16 may rotate about axis 49. Precision bearing 18 and precision bearing 20, similar to those used in the HDD, may be mounted on either end of shaft 22. Precision bearing 18 and precision bearing 20 may be housed in support 19 and support 21, and can be configured similar to the arrangement utilized in a typical HDD, or in the top cover and base plate of the head disk assembly. Coil 16 may be positioned between magnet 15A and magnet 15B, similar to an HDD. In one embodiment, an actuator arm 17 with two heads may have significantly lower inertia than an actuator arm with eight heads, as in the HDD arrangement shown in FIG. 1. The parameters of coil 16, magnet 15A, magnet 15B, backing plate 14A, and backing plate 14B can be optimized to maintain a magnetic field over a longer distance “f” to allow the actuator to achieve access times at least close to that of the HDD. In an exemplary embodiment, actuator rotor assembly 17 may move vertically such that coil 16 traverses the length “f” as recording heads 10 access other platters 9 in the FMD disk stack. The outer housing of bearing 18 and bearing 20, magnets 15A, magnet 15B, plate 14A, and plate 14B are attached to the drive housing similar to an HDD arrangement. It is possible in this configuration that the magnetic field intensity in the air gap between pole 15A and pole 15B may vary as shown by chart 92 in FIG. 13. This variation, for example, between position 16A and position 16B may result in different data access times. The variation could be acceptable in certain installations and it may also include storing the Voice Coil motor parameters for each platter location.

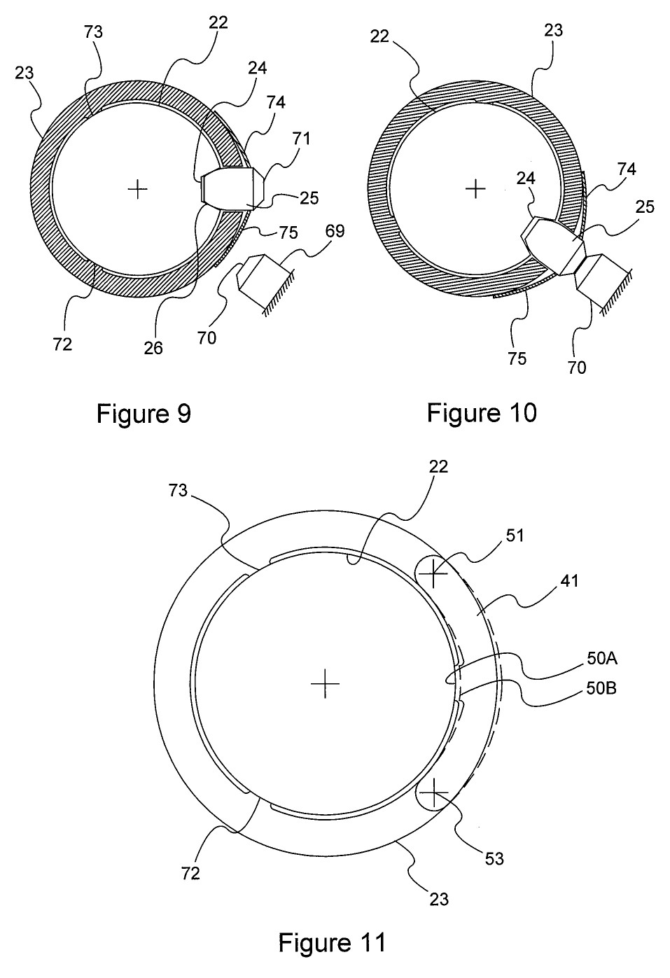

In one embodiment, to achieve vertical translation of actuator rotor 17, actuator rotor 17 must be disengaged from shaft 22 so that no axial loads beyond what bearing 18 and bearing 20 may experience in an HDD are created. One possible arrangement is depicted in FIG. 9. Shaft 22 and ring 23, which are features contained in actuator rotor 17, have a pawl 25. Pawl 25 may be spring loaded towards groove 24 in shaft 22 and may be contained in actuator rotor 17 by attaching to leaf spring member 74 and leaf spring member 75. Leaf spring 74 and leaf spring 75 may be designed to exert the force necessary to keep pawl 25 in groove 24, and may be attached to actuator arm 17. Additionally, pawl 25 can be made of 400 series Stainless or an equivalent magnetic material. A magnet 69 may be located having a face 70. When actuator arm 17 is moved to a home position such as the retracted position, such as is described later in this disclosure, pawl 25 may disengage from groove 24 contained in shaft 22 by the attraction of magnet 69, allowing the rotary actuator assembly to be moved vertically along shaft 22.

This disengaged position is illustrated in FIG. 10. When actuator arm 17 is not in the retracted position, pawl 25 may be engaged in groove 24, possibly keeping actuator arm 17 locked to shaft 22. Groove 24 may be machined in shaft 22, and the features 72 and 73 in actuator arm 17 may be fabricated with the necessary precision to keep the face of arms 12 parallel to the disk surface when pawl 25 is engaged at different locations along shaft 22, and to keep the actuator rotary assembly centered with the rotational axis 49 of the actuator. Pawl 25 can have a surface contour 26 fabricated in it to allow point or line contact with groove 24, while in this or other embodiments, pawl could have a rough surface to allow good contact with the shaft. The size of face 71 on pawl 25, and face 70 on magnet 69, can be selected to minimize any influence magnet 69 may have on the actuator accessing performance at positions close to the retracted position. In another embodiment, magnet 70 could be constructed as a soft iron core with a wire coiled around it, such that magnet force is only developed by passing current through the coiled wire, when surface 71 and surface 70 face each other to overcome this problem.

An alternative embodiment is shown is FIG. 11. In this arrangement, a piezoelectric element 41 is utilized and is contained in actuator arm 17 and attached at point 51 and point 53 to ring 23. Piezoelectric element 41 can be polarized to be in a contracted position where it is contacting shaft 22 at point 50A with a suitable force, and when energized it opens to position 50B, disengaging actuator arm 17 from shaft 22. In other embodiments, the piezoelectric element could operate in the reverse manner, particularly in arrangements where actuator arm 17 may be supported from moving along shaft 22 when power is removed from the unit. As can be seen in FIG. 11, no change may be required to shaft 22 which can be the same as used in an HDD. Additionally, the contact force and point 72, point 73 and point 50 can be designed to achieve the required precision for the actuator rotor arm.

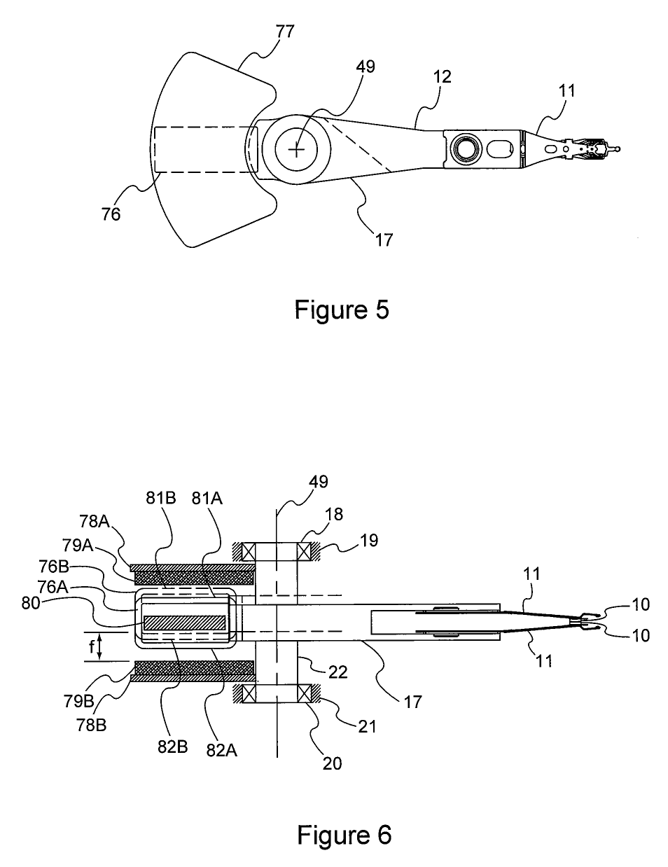

The actuator rotor arm configuration illustrated in FIGS. 3 and 4 may use magnets, backing plates and coil that are commonly used in an HDD and therefore it would require minimal changes to manufacturing tooling and assembly fixtures. However, this configuration may not offer access times that are the same on all disk platters as discussed earlier. FIGS. 5 and 6 illustrate another exemplary embodiment of the actuator assembly. In this embodiment, flat coil 16 may be replaced by a rectangular coil 76. The coil may be attached to actuator arm 17. The magnetic structure may include plate 78A, plate 78B, magnet 79A, and magnet 79B. End plates, not shown in the figures, may be utilized to form a magnetic path with center plate 80. The magnetic field intensity in these two air gaps is illustrated in FIG. 14 as chart 93 and chart 94.

Coil 76 may move around center plate 80, and face 81A may be close to pole piece 79A while face 82A is close to magnetic pole piece 79B. It can be appreciated from the figures that a new actuator rotor position such as position 76B shown for actuator arm 17 and coil 76 in dashed lines may cause coil face 81B to be closer to magnetic pole 79A, and coil face 82B to become distant from magnetic pole 79B by a similar amount. The force generated by coil face 81B may be larger than when it was at position 81A. The reverse may be true for coil face 82B and coil face 82A. It is thus possible to design the structure such that the voice coil motor torque may be the same over the entire translation zone “f”, and achieve the same accessing performance on all disk platters. There may be a rotational torque component that will develop due to differential forces on coil faces, for example, coil face 81B and coil face 82B. The coil structure can be designed to have a stiffness such that the frequency contribution of this torque may be separated from the zero db crossover point of the servo loop to have negligible impact on both track following and seek operations.

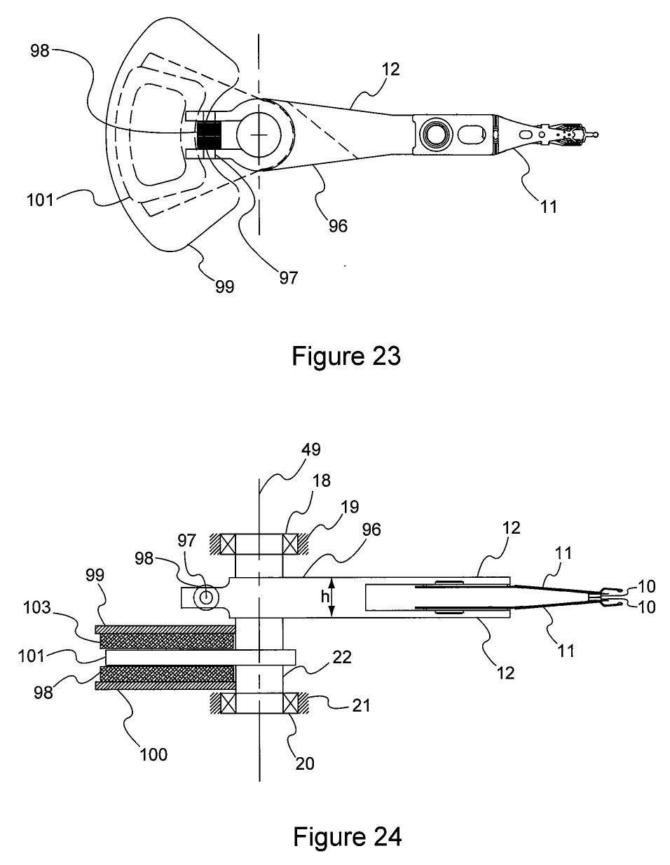

FIG. 23 and FIG. 24 illustrate another embodiment for actuating the recording heads, both over the disk surfaces, and in the perpendicular direction to access other disks in the stack. This embodiment utilizes a flat coil similar to the configuration shown in FIG. 3 and FIG. 4, except 101 is firmly attached to shaft 22. The payload of heads 10, gimbals 11, and arms 12 is much lower than a HDD with eight recording heads and four disk platters. Coil 101, actuator magnet 103, actuator magnet 98, supporting plate 99, and supporting plate 100 can be made thinner to achieve similar accessing performance.

Rotor 96 is clamped to shaft 22 and on the end opposing the head-gimbal structure, and in one embodiment, a piezoelectric actuator may be utilized to unclamp the rotor to allow it to be moved along axis 49. This piezoelectric actuator could also be arranged to operate where upon actuation it clamps rotor 96 to shaft 22. In the embodiment illustrated in FIG. 24, polarized piezoelectric disks are employed and these disks may increase in length upon the application of a voltage, disengaging rotor 96 from shaft 22; when this voltage is removed rotor 96 may be clamped to shaft 22. The clamping force and the thickness of rotor 96, “h”, can be selected to provide sufficient rigidity for servo control of heads 10, and to achieve perpendicularity of the arms in relation to axis 49. It should be recognized that axis 49 may be parallel to the axis of the spindle motor about which disks 9 rotate at high speed. One advantage of this embodiment is that the head actuator system can be optimized to achieve a suitable accessing performance, and this may be independent of the location of rotor 96 along pivot shaft 22. Additionally, coil 101, magnet 103, magnet 98, supporting plate 99, and supporting plate 100 are similar to components presently used in HDD products. One other feature of this embodiment is that the inertia of rotor 96 can be made small to eliminate any slip between rotor 96 and shaft 22 under dynamic conditions, while utilizing a smaller clamping force. This may allow a lower voltage to be used to energize the piezoelectric actuator.

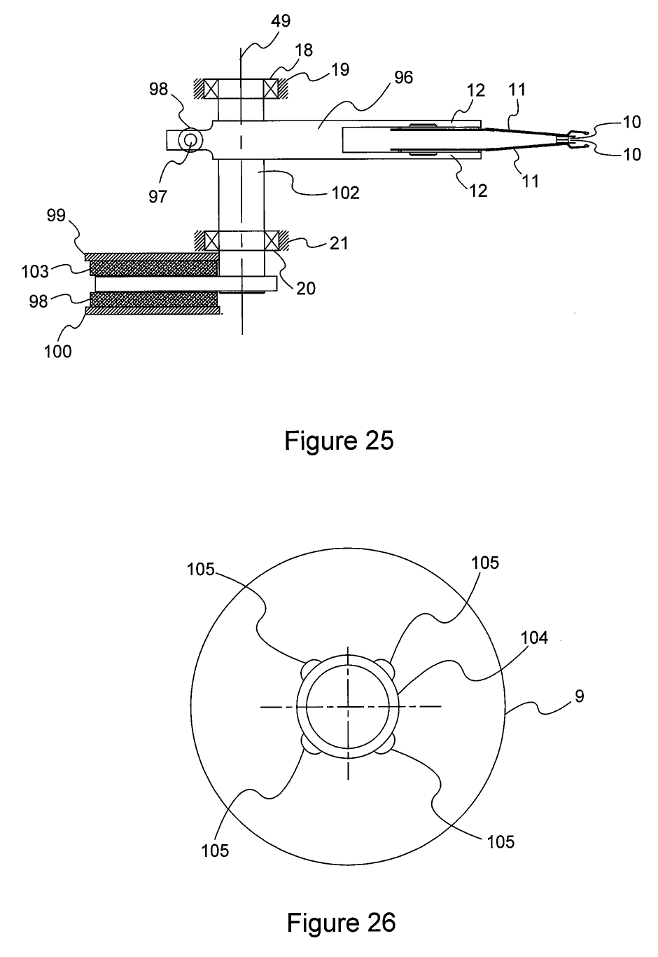

FIG. 25 illustrates an exemplary embodiment of the head actuator system where coil 101 may be located outside the bearing mounts. Such an arrangement, along with a longer shaft 102, could be utilized to keep these components outside the head disk assembly. This may be useful in certain product configurations. Additionally, both this arrangement and the spindle motor driving elements could be housed outside the head disk assembly for easy removal and replacement in the event of failure.

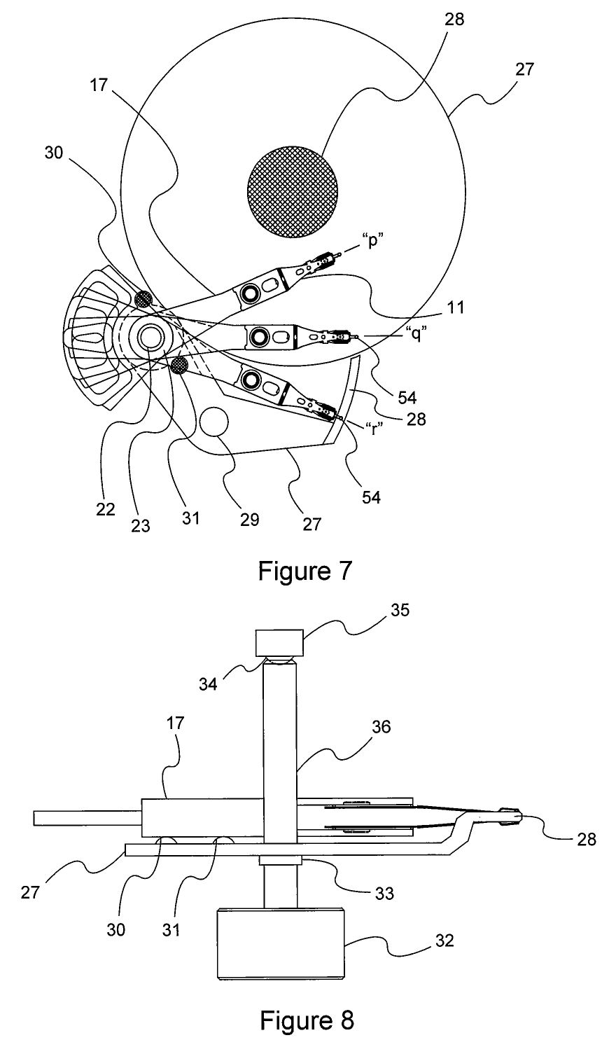

FIG. 7 and FIG. 8 illustrate the elements that move actuator arm 17 along an axis that is perpendicular to the face of the disk. FIG. 7 shows the mechanism in plan view. Actuator arm 17 is shown in three positions, one of which is labeled as “r,” which may be the retracted position. In this location the entire actuator arm assembly may be outside disk 27. The position labeled “q” may be the location where the head just after it is launched on to disk 27, and in position “p” the head may be located at the innermost data track. The pawl and piezoelectric element shown in FIG. 9, FIG. 10 and FIG. 11 engage shaft 22 at positions labeled “p,” “q,” and all position between these locations. At position “r” shaft 22 may not be attached to actuator arm 17, instead the arm may be supported by pin 30 and pin 31 mounted on plate 27. Pin 30 and pin 31 may have rounded ends or an appropriate contour to allow 17 to move into position “r” from any location such as “p” or “q.” Plate 27 may have a lead screw attached at point 29 and a head cam surface 28. Feature 54 in gimbal 11 moves over the fabricated contour 28 on plate 27. Contour 28 can be optimized to allow the recording head 10 to be optimally launched onto plate 27 such that there is no head to disk contact during both the retract and launch sequence. In other embodiments the gimbal and head could be positioned on the disk while cam 28 is still supporting the head, and then the cam is retracted away launching the heads. Retract would consist of these operations occurring in the reverse manner.

FIG. 8 illustrates the details of the lead-screw mechanism. A stepper motor 32 drives a lead-screw shaft 36. Nut 33 is attached to plate 27 at point 29. The other end of the lead-screw interfaces with a ball end point 34 contained in housing 35. The latter element is attached to the disk drive structure. In one embodiment, the lead screw, stepper motor, and nut are similar to ones used in the 3½″ Floppy Disk Drive in the actuator mechanism. This could be the least expensive configuration. The Floppy Disk Drive lead screw has a pitch that provides a linear motion of 0.1875 mm for each step of motor 32. In this configuration three steps would move actuator arm 17 by 0.56 mm. If disk spacing, t₂, of 0.56 mm is used, a common Floppy mechanism could be utilized with a total component cost of less than $5. For a twelve platter disk stack it may require thirty-six steps to move actuator arm from the lowest disk to the upper-most disk, or 108 milli-second. The average move time (⅓ stroke) may then be about 36 milli-second. Assuming a settling time of 15 milli-second to allow the dynamics to decay prior to engaging shaft 22 with either pawl 25 or the piezoelectric 41, a 51 milli-second time may result as the average “head switch” time, and the maximum head switch time may be 123 milli-second. It should be recognized that plate 27 may move the entire head-arm-coil assembly. The payload of this arm may be very small compared to a Floppy head carriage assembly, and it may be possible to optimize and reduce the access times for the Floppy stepper motor and lead-screw mechanism. Alternate mechanisms could be implemented that utilize faster motors or a Voice Coil actuator system to reduce these times. However, plate 27 with all its payload may not be balanced sufficiently to allow rapid motion similar to the rotary motion along the face of each disk platter. Thus, this actuator arrangement may provide two-speed accessing with the head switch access time across disk platters being longer than the track to track access time on each platter. These long head switch times can be masked in a multi-spindle installation such as a RAID.

It should be recognized that there may be some vertical slippage when pawl 25 and piezoelectric 41 engage shaft 22. This slip may result in one head getting closer to the disk surface while the other is moved away, and at some point this differential may result in the signal amplitude of one head becoming measurably larger than the other head. The actuator rotor arm can then be retracted and relocated by pin 30 and pin 31.

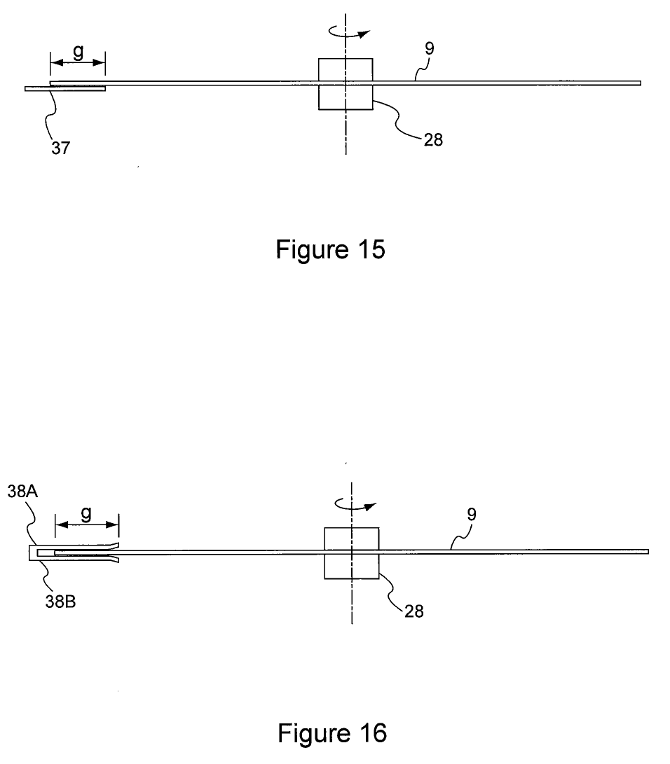

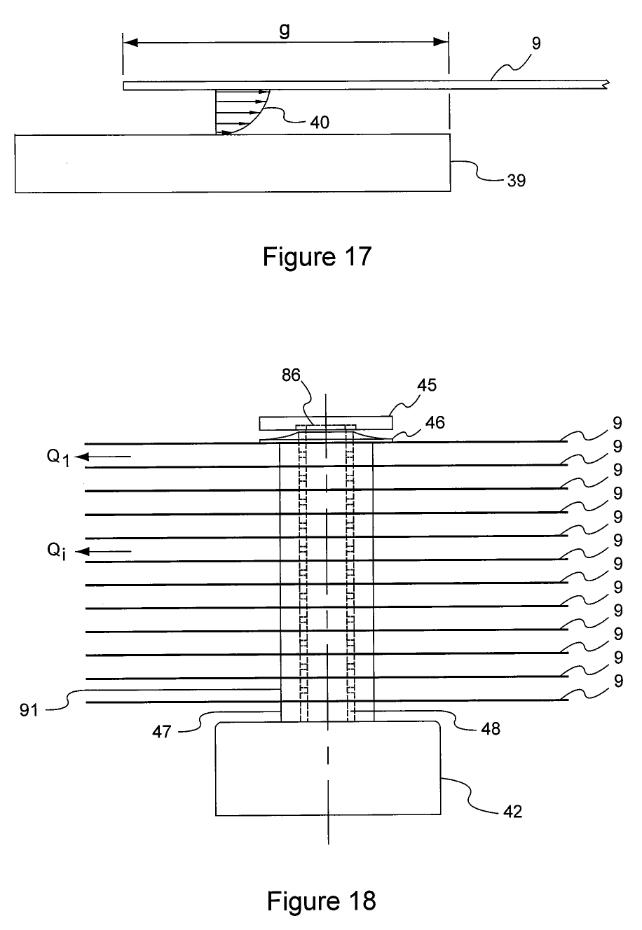

The positioning accuracy of actuator arm 17 as it is driven along the axis perpendicular to the disks, and the stacking tolerance of disks 9 on the spindle motor, could result in a mismatch such that the recording heads and the disk may not achieve reliable head retract or load operation. A plate 37 that has a flat smooth surface can be attached to plate 27. The arrangement of this plate 37 is illustrated in FIG. 15. FD 9 may rotate about spindle 28 at high speed. When plate 37 is brought in the vicinity of disk 9, an equilibrium of inertial, structural and fluid dynamic forces may occur. FIG. 17 illustrates the action of the air viscosity at the plate disk interface. Merely by way of example, plate 39 may be kept stationary while disk 9 operates at a high speed. A velocity profile such as chart 40 may be created due to air viscosity effects between these two surfaces.

As a result of a balance of the inertial, structural and fluid dynamic forces created at the plate-disk interface, a plate-to-disk separation may be established which is a function of the various system parameters such as the disk rotational speed, fluid flow in the vicinity of the disk, disk thickness, overlap area, and air viscosity. This equilibrium may result in disk 9 attaining a controlled position with respect to plate 39. By locating plate 37 and plate 27 in an appropriate relationship to the head cam surface 28 and utilizing the flexibility of disk 9, the tolerance between the recording head and the disk can be removed to achieve reliable head load/unload operation. FIG. 16 illustrates another embodiment where plate 38A and plate 38B are attached to platform 27, addressing both sides of disk 9.

The overlap length “g,” along with the area of overlap between the plate and the spinning disk, can be optimized to achieve the desired functionality. It should be understood that this arrangement may allow disk 9 to overcome flutter and axial runout for improved servo performance, namely where the head follows each data track for improved recording performance. The parameters such as disk thickness, overlap area, disk speed can be varied as necessary to achieve satisfactory stability of disk 9. Additionally, in one embodiment, it should be understood that plate 37, plate 38A, and plate 38B may be moved into the disk zone by the motion of the rotary actuator arm, and are retracted out of the disk zone to allow plate 27 to be moved along the axis perpendicular to the disks. In another embodiment, plate 37 and plate 38 could be spring loaded to achieve the overlap “g,” and the force of the actuator rotor 17 moving into the retracted position may move these plates away from the zone containing the disk.

In yet another embodiment, where a stack of heads are arranged on the actuator such that at least one head operates on each disk surface, plate 37 and plate 38 may be arranged in the vicinity of each of the disks 9, and may be kept stationary and attached to the housing with a suitable relationship to each disk 9. In such an embodiment, there may be no need to move the recording heads along an axis perpendicular to the disk surfaces. The actuator may only move the heads over the surface of the disks to access the data tracks.

Plate 37 and plate 38 can be fabricated with an entrance and exit taper to allow a spinning disk to be stabilized. The single plate arrangement 37 of FIG. 15, or the dual plates 38 shown in FIG. 16, can be used to remove instabilities that may occur when disk 9 may be rotated at very high speeds. In other embodiments, plate 37 and plate 38 can be attached to the housing and positioned at each disk in the stack to remove at least some or all of the instability that may arise due to turbulence between the housing and the rotating disks.

The mechanical arrangement depicted in FIG. 7 and FIG. 8 can be changed to allow the lead screw and stepper motor to be located outside a shroud that encloses the recording heads and the FD's. This may eliminate lead-screw lubricants or wear particles from entering the head-disk enclosure and contaminating the head and/or disk surfaces.

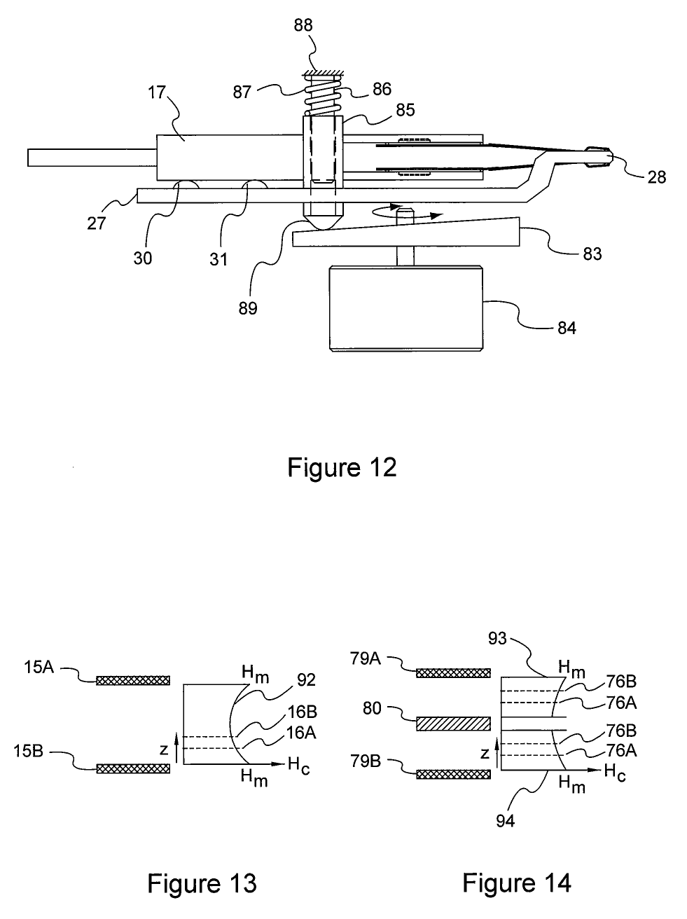

FIG. 12 illustrates a cam 83 that is driven by motor 84, which could, merely by way of example, be a stepper motor or a servo motor. A cylindrical shaft 85 having an end 89 may be utilized to follow the cam surface. Shaft 85 rides over shaft 86 that may be attached to the disk drive housing at 88. A spring 87 may be used to load end 89 against cam 83. Shaft 85 may be rigidly connected to plate 27 at point 29 as described earlier. The vertical motion of 27 may now be controlled by the cam profile on cam 83. This arrangement could be utilized to minimize generation of wear particles and the release of lubricants that may occur in a lead-screw and nut drive system. The outer surface of shaft 86, and the inner surface of shaft 85, could have a dry lubricant to prevent metal to metal contact and the generation of wear particles. Cam 83 and motor 84 could be mounted external to the head-disk assembly also the functionality depicted could be accomplished with a suitable cam and a linear motor if desired.

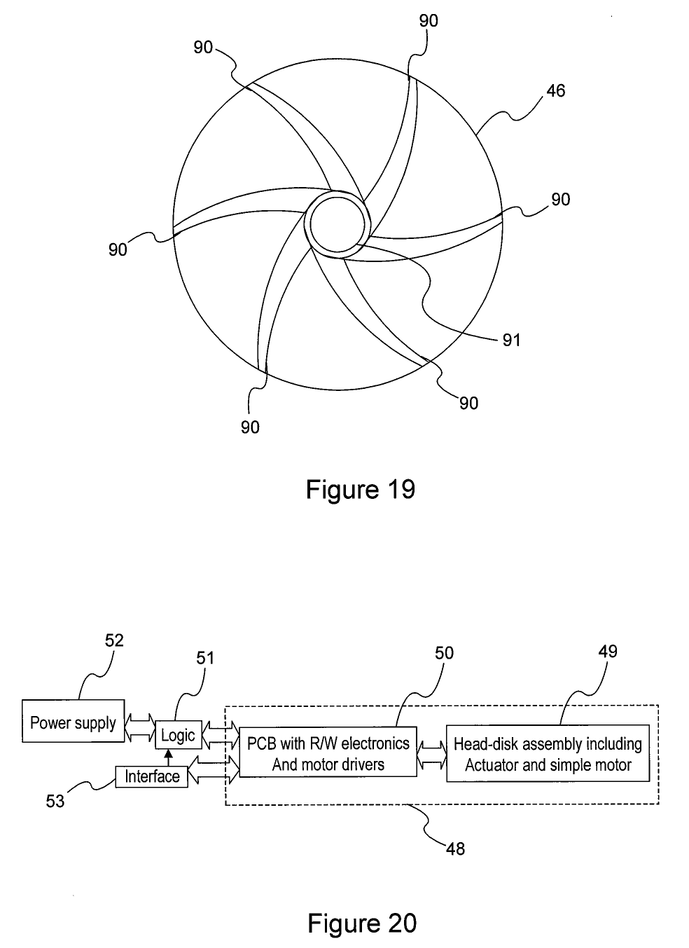

Air flow in the space between FD's is shown in FIG. 18. The FD's are mounted to a spindle shaft 47 which may have an annular cavity 48. The FD's may be spaced apart by porous spacer disks 91. Motor 42 may rotate these disks at high speed. The spindle shaft 47 may have openings that allow air to flow such as Qi to keep the FD's stable. In the event the air flow generated by the rotation of the FD's does not create an adequate pressure drop to supply these air flows, a compressor could be implemented using an impeller plate 46 such as the one shown in FIG. 19. The compressor plate 46 may have impeller blades 90 configured to create high pressure air around the central opening 91. Impeller plate 46 may be attached to the spindle and may operate against plate 45. This high pressure would feed the cylindrical space 48 and create the flows Qi between the individual FD's. Additionally, the thickness of the FD's can be increased to attain better stability if necessary. It should be recognized that the larger the thickness of each FD the less its compliance, and the greater the influence of global platter flatness and vertical runout, the flying characteristics of the recording heads 10 may be influenced. It should be appreciated that the porosity of spacers such as 91 could be varied between the various FD platters to attain a stable spinning disk pack.

In another embodiment, flexible disks 9 can be fabricated with holes 105 in the substrate that are located close to the inner clamp diameter 104 of this disk. These holes 105 may allow air to flow between the space separating individual disks 9 in a disk stack to equalize air pressures, and the disks may attain a planar and flat configuration while they operate a high speeds. Holes 105 in other embodiments can be designed to also weaken the disk and remove disk clamping distortion.

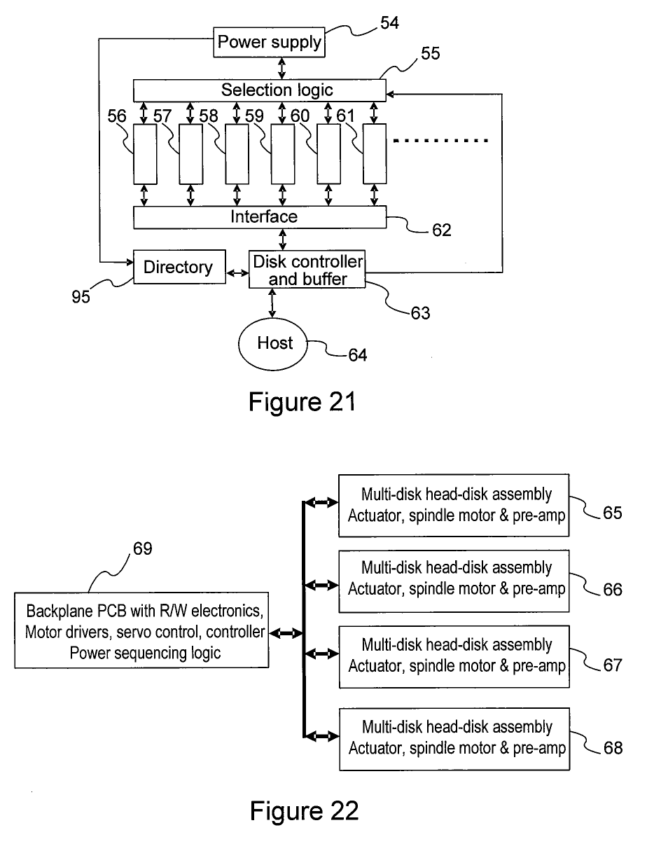

Earlier in this disclosure, smaller form factor disk drives that utilize multiple flexible disk platters and at least two recording heads such that the disk is loaded from both sides were described. In one embodiment, a disk drive made with 65 mm diameter disks could be realized in a foot-print of 100 mm×70 mm. An 8 mm tape cartridge may have dimensions of approximately 94 mm×63.5 mm×15.2 mm. This tape cartridge must be installed in a tape drive and operated in a sequential seek mode for data to be read from or written to the tape. The multi-platter disk drive could be built with a smaller diameter disk such as 58.5 mm to replicate the form factor of the 8 mm tape cartridge. It should be noted that the diameter of the flexible disk can be established as the last stage in the fabrication process when the disk is punched from a sheet of material. In the thickness of 15 mm, twelve flexible disks, 0.001 inch thick and spaced 0.63 mm apart, can be accommodated, compared to five platters, discussed earlier, in a 9.5 mm thick product. The product could offer average access times less than 15 milli-second on a particular disk platter and 51 milli-second to retract the heads from one platter and load them onto another platter, which may be faster than what a tape drive could achieve. Additionally, it is possible to mount these drives in an enclosure with a back plane. The back plane can have connectors that attach the PCB on each one of these drives to a data controller. The drives could also have minimal electronics on each unit to lower its cost. For example, the data controller functions could be moved out of each drive and into the frame that accommodates a multiplicity of such drives. This controller could select any one drive in the array such that only that specific drive may be powered-up and information written or read from this drive at speeds much faster than a tape and tape drive arrangement. This configuration is illustrated in FIG. 20 and FIG. 21.

FIG. 20 illustrates a disk drive 48 which consists of a head-disk assembly 49 made up of a stack of flexible disks mounted to a spindle motor and an actuator assembly to move the recording heads as discussed earlier. This assembly would also include the pre-amplifier IC as may be typically used in hard disk drives to amplify the head signals. A reduced set of electronics may be mounted to the PCB 50 attached to head-disk assembly 49. The components in one embodiment may include the read/write electronics circuits, the spindle, and actuator motor drivers. This drive could be realized for a lower cost as the disk controller and buffer memory may not be included in drive 48. The drive may be connected to power supply 52 through a logic circuit 51 which can selectively power a specific drive in an array of units.

The interface 53 could be open collector signal lines. FIG. 21 illustrates this arrangement. Merely by way of example, drives 48 of FIG. 18 may be arranged in an array 56, 57, 58, 59, 60, 61. All drives may connect to a selection logic block 55 which selectively powers any one of drives 56, 57, 58, 59, 60, 61. The interface signal lines connect the selected unit to the host though the disk controller and buffer memory 63. In other embodiments, controller 63 could be multiplexed to allow a multiple number of drives to be operational, reading or writing data, at the same time. A drive unit 95, which may be a traditional HDD, could be provided containing a directory of information to allow the selection of the appropriate unit and disk platter in drives 56, 57, 58, 59, 60, 61. This arrangement could be utilized in place of a tape library where a rack with a power supply 54, selection logic 55, a backplane with the interface signal lines 62, and a single disk controller are arranged to search and retrieve, or write archival data. This embodiment provides expandability where additional units such as drive 56 could be added to increase the data bank, and where information may be retrieved using random access rather than sequential access of a tape drive mechanism. This array would eliminate the regular handling of individual drive units such as drives 56, 57, 58, 59, 60, 61.

In another embodiment illustrated in FIG. 22, drive units 65, 66, 67, 68 may operate similar to the head disk assembly similar in a hard disk drive. The drive units 65, 66, 67, 68 may have the pre-amplifier IC to condition the signal read-back from the disk and to create appropriate write currents to write information on to the disks. All other electronics including the motor drivers may be located on the blackplane 69. In this embodiment, the electronics can be shared by a number of drive units 65, 66, 67, 68. Additionally, calibration data associated with the head positioning actuator, or the recording heads, could be written on a service track on each drive unit 65, 66, 67, 68, and can be loaded into memory in backplane 69 for the control of the respective unit's electro-mechanical elements. One benefit of this arrangement is that each drive unit, for example drive unit 65, could have about thirteen disks with two recording heads, while the cost of electronics and the power supply may be shared by a number of units, reducing both cost and power consumption. Both of these parameters are of great importance as the need for storage of more and more digital data continues to grow very rapidly.

Multiple exemplary embodiments have now been described in detail for the purposes of clarity and understanding. However, it will be appreciated that certain changes and modifications may be practiced within the scope of the appended claims. Therefore, the scope and content of the invention is not limited by the foregoing description.

What is claimed is:

1. A data storage system comprising:
a housing;
a spindle motor coupled with the housing;
a plurality of flexible disks spaced apart from each other and operably coupled with the spindle motor to rotate therewith, wherein the plurality of flexible disks comprise a first flexible disk and a second flexible disk;
a first head configured to engage the first face of the first flexible disk;
a second head configured to engage the second face of the first flexible disk, wherein the second head is aligned substantially parallel with the first head;
a first mechanism configured to move both the first head and the second head along both the first face and the second face of the first flexible disk;
a second mechanism configured to move both the first head and the second head in a plane substantially perpendicular to the first flexible disk and position them to engage the second flexible disk; and
wherein at least one of the first head and the second head comprises a transducer configured to read and write information on at least one face of at least one of the plurality of flexible disks.

2. The data storage system of claim 1, wherein at least one of the plurality of flexible disks comprises a metallic substrate.

3. The data storage system of claim 1, wherein at least one of the plurality of flexible disks comprises a glass substrate.

4. The data storage system of claim 1, wherein at least one of the plurality of flexible disks comprises a polymeric substrate.

5. The data storage system of claim 1, wherein the second mechanism comprises:
at least one magnet generating a magnetic field; and
an electric coil coupled with the first head and the second head, wherein the electric coil is configured to generate an electric field which reacts with the magnetic field causing the electric coil to move.

6. The data storage system of claim 1, wherein the second mechanism comprises a magnetic coupling, wherein the magnetic coupling is configured to at least partially uncouple the first head and the second head from the first mechanism.

7. The data storage system of claim 1, wherein the second mechanism comprises a piezoelectric coupling, wherein the piezoelectric coupling is configured to at least partially uncouple the first head and the second head from the first mechanism.

8. A data storage system comprising:
a housing;
a spindle motor coupled with the housing;
a plurality of flexible disks spaced apart from each other and operably coupled with the spindle motor to rotate therewith;
a magnet structure coupled with the housing, wherein the magnet structure generates a magnetic field in an air gap;
an arm configured to rotate around a first axis, wherein the arm comprises a coil at a first end of the arm, and at least one head at a second end of the arm, and wherein the coil is at least partially located in the air gap and is configured to move in a plane substantially perpendicular to the first axis; and
a platform operably coupled with an actuator coupled with the housing, wherein the actuator is configured to move the platform along the first axis, and wherein the platform is configured to move the arm along the first axis when the arm is at a home position.

9. The data storage system of claim 8, wherein at least one of the plurality of flexible disks comprises a metallic substrate.

10. The data storage system of claim 8, wherein at least one of the plurality of flexible disks comprises a glass substrate.

11. The data storage system of claim 8, wherein at least one of the plurality of flexible disks comprises a polymeric substrate.

12. The data storage system of claim 8, wherein the coil being configured to move in a plane substantially perpendicular to the first axis comprises the coil being configured to generate an electrical field which reacts with the magnetic field causing the coil to move.

13. The data storage system of claim 8, wherein the platform comprises raised contoured portions configured to support the arms in a position such that no head to disk contact during both a retract and a launch sequence of the head.

14. The data storage system of claim 8, wherein the arm being configured to rotate around a first axis comprises the arm coupled with a shaft, and wherein the actuator comprises a magnetic coupling, wherein the magnetic coupling is configured to at least partially uncouple the arm from the shaft.

15. The data storage system of claim 8, wherein the arm being configured to rotate around a first axis comprises the arm coupled with a shaft, and wherein the actuator comprises a piezoelectric coupling, wherein the piezoelectric coupling is configured to at least partially uncouple the arm from the shaft.

16. The data storage system of claim 8, the arm being configured to rotate around a first axis comprises the arm coupled with a shaft having a first end and a second end, and wherein the magnet structure is coupled with the shaft in substantial proximity to the first end.

17. A data storage system comprising:
a first means for storing data;
a second means for storing data;
a third means for rotating the first means and the second means;
a fourth means for providing air flow between the first means and the second means;
a fifth means for reading or writing data;
a sixth means for moving the fifth means between different portions of either one of the first means or the second means; and
a seventh means for moving the fifth means from the first means and the second means.

18. The data storage system of claim 17, wherein the third means comprises the fourth means.

19. The data storage system of claim 17, wherein the third means comprises the fourth means.

20. The data storage system of claim 17, wherein:
the first means and the second means each comprise a flexible disk, wherein each flexible disk comprises a first side and a second side; and
the fifth means comprises:
a first head configured to access the first side of a particular disk; and
a second head configured to access the second side of the particular disk.
